(19) United States
(12) Patent Application Publication
(10) Pub. No.: US 2025/0088044 A1
(43) Pub. Date: Mar. 13, 2025

(54) CHARGING DEVICE

(71) Applicant: Panasonic Automotive Systems Co., Ltd., Kanagawa (JP)

(72) Inventor: Jumpei IWASA, Tokyo To (JP)

(73) Assignee: Panasonic Automotive Systems Co., Ltd., Kanagawa (JP)

(21) Appl. No.: 18/958,864

(22) Filed: Nov. 25, 2024

Related U.S. Application Data
(63) Continuation of application No. PCT/JP2023/020347, filed on May 31, 2023.

(30) Foreign Application Priority Data
Jun. 2, 2022 (JP) 2022-090097

(51) Int. Cl. H02J 50/90; H02J 50/12

(52) U.S. Cl. CPC H02J 50/90; H02J 50/12

(57) ABSTRACT

A charging device is wirelessly charges a terminal device having a power receiver that is disposed on a placement surface and receives wirelessly transmitted power. The charging device includes: a power transmission coil that transmits power to the terminal device; a processor coupled to a memory and configured to cause the power transmission coil to transmit power; a detection coil for detecting an arrangement position of the terminal device on the placement surface; a signal transmitter that outputs, to the detection coil, a first signal for generating a detection magnetic field; and a signal detector that detects an echo signal returned from the terminal device to the detection coil in response to the detection magnetic field. The processor is further configured to determine whether the terminal device is present within an estimated chargeable range by the power transmission coil, based on a detection result of the echo signal.

### CROSS-REFERENCE TO RELATED APPLICATIONS

This application is a continuation of International Application No. PCT/JP2023/020347, filed on May 31, 2023 which claims the benefit of priority of the prior Japanese Patent Application No. 2022-090097, filed on Jun. 2, 2022, the entire contents of which are incorporated herein by reference.

### FIELD

The present disclosure relates to a charging device.

### BACKGROUND

A device that wirelessly charges a terminal device with a built-in battery is known. For example, there is disclosed a device that moves a power transmission coil to an arrangement position of a terminal device and wirelessly charges the terminal device with the power transmission coil (see, for example, JP 2009-247194 A and JP 2014-7866 A).

However, in the related art, when the terminal device is placed on the placement surface, movement of the power transmission coil is started toward the arrangement position of the terminal device, and wireless charging is started from the power transmission coil toward the terminal device. In the related art, wireless charging may be unconditionally started when a terminal device is placed on a placement surface. Therefore, in the related art, even when the terminal device is placed at a position where wireless charging is difficult, movement of the power transmission coil and wireless charging are started, and power consumption may increase. In the related art, the voltage value of the power transmission coil is compared with a predetermined constant value, and charging is started when it is determined that the state is appropriate. However, in the related art, it is assumed that communication between the power transmission coil and the terminal device is possible, and an effect in a case where the terminal device is placed at a position where wireless charging communication is difficult is limited, and it may be difficult to achieve power saving.

An object of the present disclosure is to provide a charging device capable of saving power.

### SUMMARY

A charging device according to an aspect of the present disclosure wirelessly charges a terminal device having a power receiver that is disposed on a placement surface and receives wirelessly transmitted power. The charging device includes a power transmission coil, a memory, a processor, a detection coil, a signal transmitter, and a signal detector. The power transmission coil transmits power to the terminal device. The processor is coupled to the memory and configured to cause the power transmission coil to transmit power. The detection coil is for detecting an arrangement position of the terminal device on the placement surface. The signal transmitter outputs, to the detection coil, a first signal for generating a detection magnetic field. The signal detector detects an echo signal returned from the terminal device to the detection coil in response to the detection magnetic field. The processor is further configured to determine whether the terminal device is present within an estimated chargeable range by the power transmission coil, based on a detection result of the echo signal.

### BRIEF DESCRIPTION OF THE DRAWINGS

FIG. 1 is a diagram illustrating an example of a schematic configuration of a charging system according to an embodiment;

FIG. 2 is a hardware configuration diagram of an example of a control unit;

FIG. 3 is a block diagram illustrating an example of a configuration of a charging device;

FIG. 4 is an explanatory diagram of an example of a detection coil according to the embodiment;

FIG. 5 is a diagram illustrating an example of a pulse signal and an echo signal;

FIG. 6 is a schematic diagram illustrating an example of a positional relationship between an estimated chargeable range and a terminal device;

FIG. 7 is a diagram illustrating an example of a detection result of an echo signal;

FIG. 8 is a flowchart illustrating an example of a flow of a charging process according to the embodiment;

FIG. 9 is a flowchart illustrating an example of a flow of conventional charge control;

FIG. 10A is an explanatory diagram of an example of an effect of the charging device of the present embodiment;

FIG. 10B is an explanatory diagram of an example of an effect of the charging device of the present embodiment;

FIG. 11 is a flowchart illustrating an example of the flow of the charging process according to the present embodiment;

FIG. 12A is an explanatory diagram of an example of an effect of the charging device of the present embodiment;

FIG. 12B is an explanatory diagram of an example of an effect of the charging device of the present embodiment;

FIG. 13 is a flowchart illustrating an example of the flow of the charging process according to the embodiment; and

FIG. 14 is a block diagram illustrating an example of a configuration of a charging device according to a modification example.

### DETAILED DESCRIPTION

Hereinafter, embodiments of the present disclosure will be described in detail with reference to the drawings as appropriate. However, unnecessarily detailed description may be omitted. The accompanying drawings and the following description are provided for those skilled in the art to fully understand the present disclosure, and the subject matter described in the claims is not limited by these.

### First Embodiment

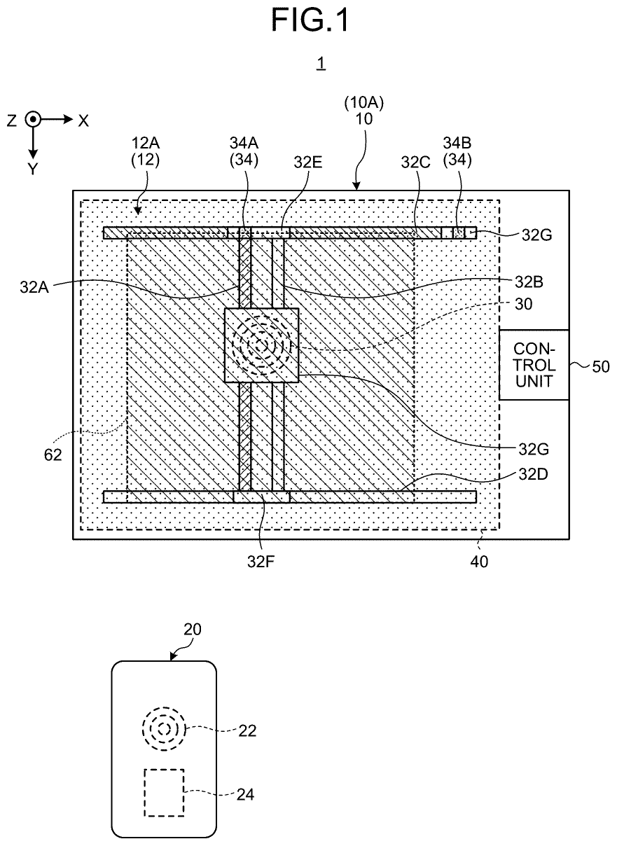

FIG. 1 is a diagram illustrating an example of a schematic configuration of a charging system 1 according to the present embodiment.

The charging system 1 includes a charging device 10A and a terminal device 20.

The charging device 10A is an example of a charging device 10. The charging device 10 is a device that wirelessly charges a terminal device 20 that has a battery 24 built therein.

Wireless charging means wireless charging. In the present embodiment, a mode in which wireless charging means charging by a magnetic induction action will be described as an example.

The terminal device 20 is a device built-in the battery 24. The terminal device 20 is, for example, a smartphone, a tablet terminal, an audio player, a mobile phone, or the like.

The terminal device 20 includes at least a power receiving unit (power receiver) 22 and a battery 24.

The power receiving unit 22 is a mechanism that receives power wirelessly transmitted from the charging device 10A. The power receiving unit 22 is, for example, a dielectric coil electromagnetically coupled to a power transmission coil 30 of the charging device 10A described later. The battery 24 is charged by the power induced in the power receiving unit 22.

A housing 12 of the charging device 10A is provided with a placement surface 12A. The placement surface 12A is a surface on which the terminal device 20 to be wirelessly charged is placed. In the present embodiment, a mode in which the placement surface 12A is a partial region of the outer surface of the housing 12 and is a two-dimensional planar region will be described as an example.

In the present embodiment, a description will be given assuming that the placement surface 12A is a two-dimensional plane along a plane defined by a first direction and a second direction orthogonal to the first direction. In addition, as illustrated in FIG. 1, a description will be given on the assumption that the first direction is an X-axis direction and the second direction is a Y-axis direction. The X-axis direction and the Y-axis direction are directions orthogonal to each other along the two-dimensional plane of the placement surface 12A. The description will be given assuming that a Z-axis direction orthogonal to the X-axis direction and the Y-axis direction coincides with the thickness direction of the housing 12.

In the housing 12 of the charging device 10A, the power transmission coil 30, a movement mechanism 34, a detection coil 40, a control unit 50, and the like are provided.

The power transmission coil 30 is a coil for transmitting power to the terminal device 20. Specifically, the power transmission coil 30 is a coil for guiding power to the power receiving unit 22 of the terminal device 20 placed on the placement surface 12A.

The movement mechanism 34 is a mechanism that moves the power transmission coil 30 along the placement surface 12A. In the present embodiment, the movement mechanism 34 includes a drive motor 34A and a drive motor 34B. The drive motor 34A is a motor for moving the power transmission coil 30 along the Y-axis direction. The drive motor 34B is a motor for moving the power transmission coil 30 along the X-axis direction.

The drive motor 34A and the drive motor 34B are coupled to a support member 32.

The support member 32 includes a screw rod member 32A, a guide rod 32B, a screw rod member 32C, a guide rod 32D, a nut 32E, a nut 32F, and a nut 32G.

The screw rod member 32A and the guide rod 32B are rod-like members extending in the Y-axis direction, and support the power transmission coil 30 via the nut 32G. In the screw rod member 32A and the guide rod 32B, one end portion in the Y-axis direction is connected to the nut 32E, and the other end portion in the Y-axis direction is connected to the nut 32F. One end portion in the Y-axis direction of the screw rod member 32A is connected to the drive motor 34A.

When the screw rod member 32A is rotated by driving of the drive motor 34A, the nut 32G supporting the power transmission coil 30 moves in the Y-axis direction that is the extending direction of the guide rod 32B, and the power transmission coil 30 moves in the Y-axis direction.

The screw rod member 32C and the guide rod 32D are rod-like members extending in the X-axis direction, and support the nut 32E and the nut 32F, respectively. One end portion of the screw rod member 32C in the extending direction is connected to the nut 32G, and the nut 32G is provided with the drive motor 34B.

When the screw rod member 32C is rotated by driving of the drive motor 34B, the nut 32E and the nut 32F supporting the power transmission coil 30 via the screw rod member 32A and the guide rod 32B move in the X-axis direction along each of the screw rod member 32C and the guide rod 32D. The movement of the nut 32E and the nut 32F in the X-axis direction moves the power transmission coil 30 in the X-axis direction.

As described above, the power transmission coil 30 is configured to be movable in the X-axis direction and the Y-axis direction along the placement surface 12A by driving of the drive motor 34A and the drive motor 34B included in the movement mechanism 34. That is, the power transmission coil 30 is configured to be movable within a movable range 62 along the placement surface 12A by the movement mechanism 34. The movable range 62 is a range in which the power transmission coil 30 can be moved by the movement mechanism 34. The movable range 62 is a region along the two-dimensional plane of the placement surface 12A and is a region occupying a part of the placement surface 12A.

Note that the movement mechanism 34 may be any mechanism as long as the mechanism moves the power transmission coil 30 along the placement surface 12A, and is not limited to the configuration illustrated in FIG. 1.

The detection coil 40 is a coil for detecting an arrangement position of the terminal device 20 on the placement surface 12A. The arrangement position of the terminal device 20 represents the arrangement position of the power receiving unit 22 provided in the terminal device 20. The arrangement position of the terminal device 20 is represented by a position on the placement surface 12A. The detection coil 40 is disposed along the placement surface 12A inside the placement surface 12A. Details of the detection coil 40 will be described later.

The control unit 50 executes information processing in the charging device 10.

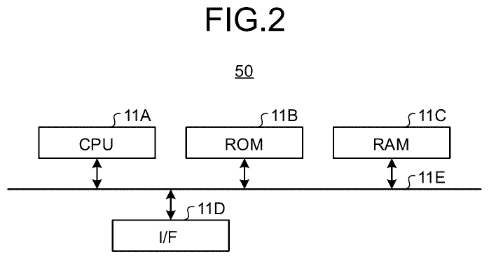

FIG. 2 is a diagram illustrating an example of a hardware configuration of the control unit 50.

The control unit 50 has a hardware configuration using a normal computer in which a central processing unit (CPU) 11A, a read only memory (ROM) 11B, a RAM 11C, an I/F 11D, and the like are mutually connected by a bus 11E.

The CPU 11A is an arithmetic device that controls the charging device 10A of the present embodiment. The ROM 11B stores programs and the like for realizing various processes by the CPU 11A. The RAM 11C stores data necessary for various processes by the CPU 11A. The I/F 11D is an interface for transmitting and receiving data.

A program for executing information processing executed by the charging device 10A of the present embodiment is provided by being incorporated in the ROM 11B or the like in advance. Note that the program executed by the charging device 10A of the present embodiment may be provided by being recorded in a computer-readable recording medium such as a CD-ROM, a flexible disk (FD), a CD-R, or a digital versatile disk (DVD) as a file in a format that can be installed or executed in the charging device 10A.

Next, the configuration of the charging device 10A will be described in detail.

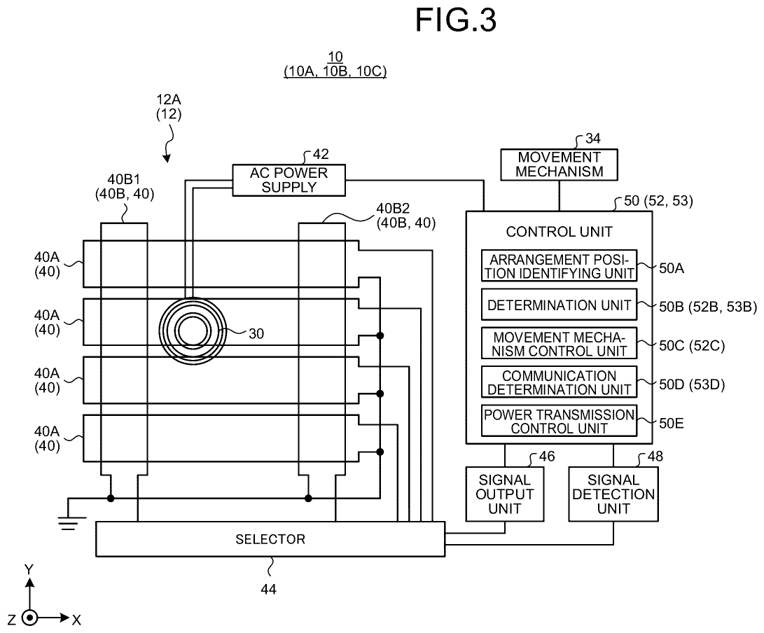

FIG. 3 is a block diagram illustrating an example of the configuration of the charging device 10A.

The charging device 10A includes a power transmission coil 30, a movement mechanism 34, a detection coil 40, an AC power supply 42, a selector 44, a signal output unit (signal transmitter) 46, a signal detection unit (signal detector) 48, and a control unit 50.

As described above, the detection coil 40 is a coil for detecting the arrangement position of the terminal device 20 on the placement surface 12A.

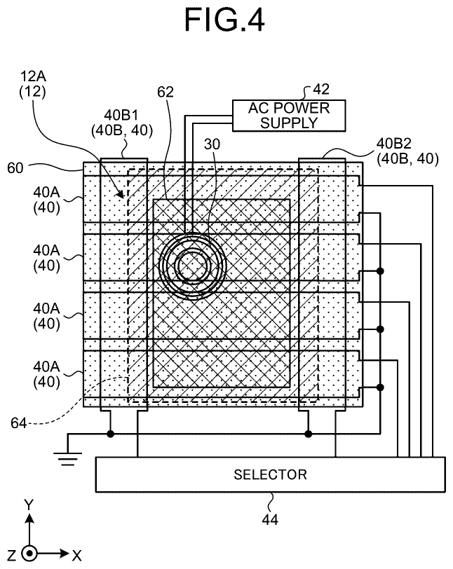

FIG. 4 is an explanatory diagram of an example of the detection coil 40 of the present embodiment. In the present exemplary embodiment, the detection coil 40 includes a first detection coil 40A and a second detection coil 40B.

The first detection coil 40A is a coil for detecting the arrangement position of the terminal device 20 in an estimated chargeable range 64 on the placement surface 12A.

The estimated chargeable range 64 is an estimated range in which the terminal device 20 on the placement surface 12A is estimated to be chargeable. The actual chargeable range of the terminal device 20 on the placement surface 12A is determined by the movable range 62 of the power transmission coil 30, the compatibility between the power receiving unit 22 and the power transmission coil 30 of the terminal device 20, and the like. That is, the actual chargeable range is a range that is found only when the power receiving unit 22 receives power from the power transmission coil 30. It is essential that the actual chargeable range is a range wider than the movable range 62 of the power transmission coil 30, but the maximum range varies depending on compatibility between the power transmission coil 30 and the power receiving unit 22 of the terminal device 20.

In the charging device 10A of the present embodiment, a range that is wider than the movable range 62 of the power transmission coil 30 on the two-dimensional plane along the placement surface 12A and is estimated to be chargeable according to the relationship between the power transmission coil 30 and the power receiving unit 22 is set in advance as the estimated chargeable range 64.

The first detection coil 40A is disposed so as to be able to detect the arrangement position of the terminal device 20 placed at least in the estimated chargeable range 64 on the placement surface 12A.

In the present embodiment, the first detection coil 40A extends in the X-axis direction in a two-dimensional plane along the placement surface 12A, and a plurality of the first detection coils 40A are arranged along the Y-axis direction intersecting the X-axis direction in the two-dimensional plane. The plurality of first detection coils 40A are disposed so as to cover at least the entire region corresponding to the estimated chargeable range 64 in the two-dimensional plane along the placement surface 12A. FIGS. 4 and 3 illustrate, as an example, a mode in which four first detection coils 40A extending in the X-axis direction are arranged along the Y-axis direction. The number of first detection coils 40A is not limited to four as long as the number is plural.

The second detection coil 40B is a coil for detecting the arrangement position of the terminal device 20 outside the estimated chargeable range 64 on the placement surface 12A.

The second detection coil 40B is disposed so as to be able to detect the arrangement position of the terminal device 20 placed outside the estimated chargeable range 64 on the placement surface 12A.

In the present embodiment, the second detection coil 40B extends in the Y-axis direction and is disposed at both ends in the X-axis direction which is the extending direction of the first detection coil 40A. The second detection coil 40B is disposed so as to selectively cover a region that is outside the estimated chargeable range 64 in a two-dimensional plane along the placement surface 12A. For example, a second detection coil 40B1 is disposed on one end portion side in the X-axis direction of the first detection coil 40A, and a second detection coil 40B2 is disposed on the other end portion side in the X-axis direction of the first detection coil 40A. The second detection coil 40B1 and the second detection coil 40B2 are examples of the second detection coil 40B.

FIGS. 4 and 3 illustrate, as an example, an example in which the second detection coil 40B is disposed to overlap both end portions in the extending direction of the first detection coil 40A in the Z-axis direction. However, the second detection coil 40B may be disposed at both ends in the extending direction of first detection coil 40A in a non-overlapping manner. In this case, the second detection coil 40B may be disposed outside both end portions in the extending direction of the first detection coil 40A along the X-axis direction.

By arranging the first detection coil 40A and the second detection coil 40B, a detection range 60 of the terminal device 20 by the detection coil 40 including the first detection coil 40A and the second detection coil 40B includes the entire region of the movable range 62 and the estimated chargeable range 64, and is a range wider than these ranges.

Returning to FIG. 3, the description will be continued.

The first detection coil 40A and the second detection coil 40B are electrically connected to each of the signal output unit 46 and the signal detection unit 48 via the selector 44.

The signal output unit 46 outputs a first signal for generating the detection magnetic field to the detection coil 40. The signal output unit 46 selectively outputs the first signal to the predetermined detection coil 40 by switching the connection of the selector 44. The first signal is a signal for causing the detection coil 40 to generate a detection magnetic field. The first signal is, for example, a pulse signal. When the first signal is input, the detection coil 40 generates a detection magnetic field.

The signal detection unit 48 detects, via the selector 44, an echo signal returned from the terminal device 20 to the detection coil 40 in response to the detection magnetic field generated by the detection coil 40. The signal detection unit 48 switches the connection of the selector 44 to selectively detect the echo signal returned to the predetermined detection coil 40. The signal detection unit 48 outputs a detection result of the echo signal to the control unit 50.

The control unit 50 includes an arrangement position identifying unit 50A, a determination unit 50B, a movement mechanism control unit 50C, a communication determination unit 50D, and a power transmission control unit 50E.

Some or all of the arrangement position identifying unit 50A, the determination unit 50B, the movement mechanism control unit 50C, the communication determination unit 50D, and the power transmission control unit 50E may be realized, for example, by causing a processing device such as the CPU 11A to execute a program, that is, by software, may be realized by hardware such as an integrated circuit (IC), or may be realized by using software and hardware in combination.

The arrangement position identifying unit 50A identifies the arrangement position of the terminal device 20 on the basis of the detection result of the signal detection unit 48. The arrangement position identifying unit 50A identifies the arrangement position of the terminal device 20 on the basis of the level of the echo signal which is the detection result of the signal detection unit 48.

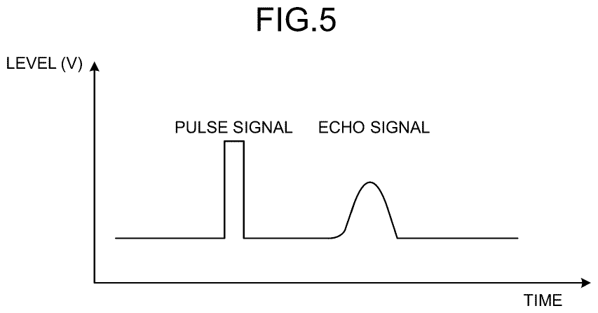

FIG. 5 is a diagram illustrating an example of a pulse signal and an echo signal. In FIG. 5, a horizontal axis represents time, and a vertical axis represents a level of a signal.

When the first signal, which is a pulse signal, is input, the detection coil 40 generates a detection magnetic field. In a case where the power receiving unit 22 of the terminal device 20 is located on the detection coil 40 that has generated the detection magnetic field, the echo signal excited by the pulse signal and guided from the power receiving unit 22 to the detection coil 40 after a predetermined time has elapsed becomes an echo signal of a predetermined level or more. On the other hand, when the power receiving unit 22 of the terminal device 20 is not located on the detection coil 40 that has generated the detection magnetic field, the echo signal excited by the pulse signal and guided from the power receiving unit 22 to the detection coil 40 after the lapse of the predetermined time becomes an echo signal of a level lower than the predetermined level.

Returning to FIG. 3, the description will be continued.

The arrangement position identifying unit 50A identifies the arrangement position on the basis of the detection result of the echo signal returned from the terminal device 20 to at least the first detection coil 40A in response to the detection magnetic field caused by the first signal output from the signal output unit 46 to at least the first detection coil 40A.

Specifically, the arrangement position identifying unit 50A determines which detection coil 40A of the plurality of first detection coils 40A the echo signal returned to is equal to or higher than a predetermined level. Through this determination, the arrangement position identifying unit 50A identifies the arrangement position of the terminal device 20 within the estimated chargeable range 64 on the placement surface 12A. Specifically, the arrangement position identifying unit 50A identifies, as the arrangement position of the terminal device 20, the position of the first detection coil 40A that has output a signal of a predetermined level or higher and an echo signal of a maximum level among echo signals of the plurality of first detection coils 40A detected by the signal detection unit 48. In the present embodiment, the plurality of first detection coils 40A are arranged along the Y-axis direction. Therefore, the arrangement position identifying unit 50A identifies the position in the Y-axis direction on the placement surface 12A as the arrangement position of the terminal device 20.

The determination unit 50B determines whether the terminal device 20 is present within the estimated chargeable range 64 by the power transmission coil 30 on the basis of the detection result of the echo signal.

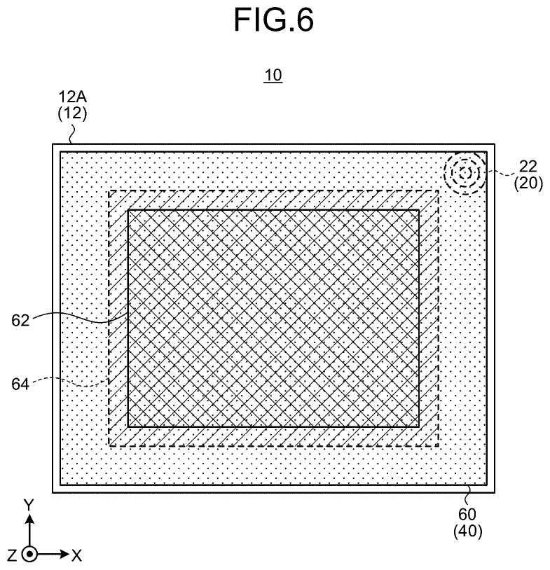

FIG. 6 is a schematic diagram illustrating an example of the positional relationship between the estimated chargeable range 64 and the power receiving unit 22 of the terminal device 20.

As described above, the detection range 60 of the terminal device 20 by the detection coil 40 is a range wider than the movable range 62 and the estimated chargeable range 64. This is because, from the viewpoint of widening the actual chargeable range as much as possible, it is necessary to secure the detection range 60 wider than the movable range 62 of the power transmission coil 30.

For example, a scene in which the power receiving unit 22 of the terminal device 20 is placed so as to be within the estimated chargeable range 64 is assumed. In this case, the terminal device 20 is wirelessly charged by moving the power transmission coil 30 to the arrangement position of the terminal device 20. On the other hand, as illustrated in FIG. 6, it is assumed that the power receiving unit 22 of the terminal device 20 is placed so as to be outside the estimated chargeable range 64. In this case, even if the power transmission coil 30 is moved toward the arrangement position of the terminal device 20, the power transmission coil 30 cannot reach the position where the terminal device 20 can be charged. Therefore, in this case, even when the power transmission coil 30 is moved, it is difficult to charge the terminal device 20 with the power transmission coil 30.

Returning to FIG. 3, the description will be continued.

Therefore, the determination unit 50B determines whether the terminal device 20 is present within the estimated chargeable range 64 of the power transmission coil 30, based on the detection result of the echo signal by the signal detection unit 48.

In detail, the determination unit 50B receives the detection result of the echo signal returned from the terminal device 20 to the second detection coil 40B in response to the detection magnetic field caused by the first signal output from the signal output unit 46 to the second detection coil 40B. Then, the determination unit 50B determines whether the terminal device 20 is present within the estimated chargeable range 64 based on the detection result.

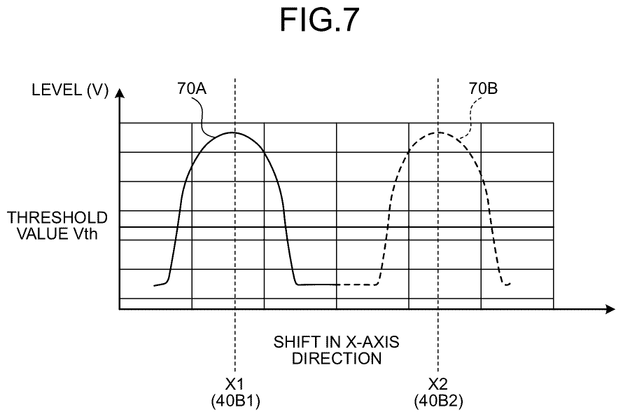

FIG. 7 is a diagram illustrating an example of a detection result of an echo signal returned to each of the second detection coil 40B1 and the second detection coil 40B2. In FIG. 7, the horizontal axis represents the deviation in the X-axis direction. “0”, which is the origin of the horizontal axis, corresponds to an intermediate position in the X-axis direction between the second detection coil 40B1 and the second detection coil 40B2. The position of deviation X1 on the horizontal axis corresponds to the position of the second detection coil 40B1 in the X-axis direction. The position of deviation X2 on the horizontal axis corresponds to the position of the second detection coil 40B2 in the X-axis direction.

In a case where the power receiving unit 22 of the terminal device 20 is present in an area corresponding to the second detection coil 40B1 or the second detection coil 40B2 on the placement surface 12A, the echo signals returned to the second detection coils 40B are as illustrated in a diagram 70A or a diagram 70B in FIG. 7.

Therefore, when the echo signal returned to the second detection coil 40B1 or the second detection coil 40B2 is equal to or larger than a threshold value Vth, the determination unit 50B determines that the terminal device 20 is outside the estimated chargeable range 64 on the placement surface 12A.

In addition, when the echo signals returned to the second detection coil 40B1 and the second detection coil 40B2 are less than the threshold value Vth, the determination unit 50B determines that the terminal device 20 does not exist outside the estimated chargeable range 64 on the placement surface 12A. That is, in this case, the determination unit 50B determines that the terminal device 20 exists within the estimated chargeable range 64.

Returning to FIG. 3, the description will be continued.

The movement mechanism control unit 50C controls the movement mechanism 34 based on the detection result by the signal detection unit 48.

In the present embodiment, when the determination unit 50B determines that the terminal device 20 is outside the estimated chargeable range 64 on the basis of the detection result, the movement mechanism control unit 50C controls the movement mechanism 34 not to move the power transmission coil 30. Controlling the movement mechanism 34 so as not to move means not transmitting a signal related to a movement instruction to the movement mechanism 34.

In addition, in a case where the determination unit 50B determines that the terminal device 20 is within the estimated chargeable range 64 on the basis of the detection result, the movement mechanism control unit 50C controls the movement mechanism 34 to move the power transmission coil 30 to the arrangement position identified by the arrangement position identifying unit 50A.

That is, in the present embodiment, when the terminal device 20 is present within the estimated chargeable range 64, the movement mechanism control unit 50C moves the power transmission coil 30 to the arrangement position identified by the arrangement position identifying unit 50A. In addition, the movement mechanism control unit 50C does not move the power transmission coil 30 when the terminal device 20 exists outside the estimated chargeable range 64.

Specifically, in the present embodiment, when the arrangement position of the terminal device 20 is identified on the basis of the detection result and it is determined that the terminal device 20 exists within the estimated chargeable range 64 on the basis of the detection result, the movement mechanism control unit 50C controls the movement mechanism 34 to move the power transmission coil 30 to the identified arrangement position.

Therefore, when the terminal device 20 is placed outside the estimated chargeable range 64, that is, at a position where it is difficult to perform wireless charging, the movement mechanism control unit 50C can avoid unnecessary movement of the power transmission coil 30.

The communication determination unit 50D determines whether the power transmission coil 30 can communicate with the terminal device 20. In the present embodiment, the communication determination unit 50D determines whether the power transmission coil 30 can communicate with the terminal device 20 when the power transmission coil 30 is moved to the arrangement position of the terminal device 20 by the control of the movement mechanism control unit 50C.

The communication determination unit 50D causes the power transmission coil 30 to transmit a communication signal via the AC power supply 42. The communication signal is, for example, PING. PING is a power signal emitted from the charging device 10 to activate the terminal device 20. When receiving a response signal to the transmitted communication signal from the power receiving unit 22 of the terminal device 20, the power transmission coil 30 outputs the response signal to the control unit 50 via the AC power supply 42. The communication determination unit 50D of the control unit 50 may determine whether communication is possible by determining a response signal to the communication signal.

The power transmission control unit 50E causes the power transmission coil 30 to transmit power. In the present embodiment, the power transmission control unit 50E controls the power transmission coil 30 to transmit power to the terminal device 20 when the communication determination unit 50D determines that communication is possible.

Specifically, the power transmission control unit 50E controls the AC power supply 42 to supply AC power from the AC power supply 42 to the power transmission coil 30. The power transmission coil 30 is electromagnetically coupled to the power receiving unit 22 of the terminal device 20 to supply the AC power to the power receiving unit 22. The AC power supplied to the power receiving unit 22 is converted into DC power by a rectifier provided in the terminal device 20 to charge the battery 24. Therefore, the battery 24 of the terminal device 20 is wirelessly charged.

Next, an example of a flow of a charging process executed by the charging device 10A of the present embodiment will be described.

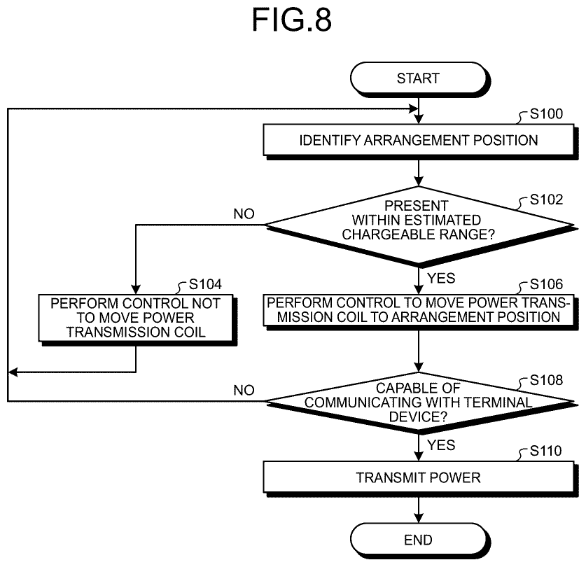

FIG. 8 is a flowchart illustrating an example of the flow of the charging process executed by the charging device 10A of the present embodiment.

The arrangement position identifying unit 50A identifies the arrangement position of the terminal device 20 based on the detection result of the signal detection unit 48 (Step S100). The arrangement position identifying unit 50A receives the detection result of the echo signal returned from the terminal device 20 to the first detection coil 40A in response to the detection magnetic field caused by the first signal output from the signal output unit 46 to the first detection coil 40A. Then, the arrangement position identifying unit 50A identifies the arrangement position based on the received detection result.

The determination unit 50B determines whether the terminal device 20 is present within the estimated chargeable range 64 of the power transmission coil 30 based on the detection result of the echo signal (Step S102). The determination unit 50B determines whether the echo signals returned to the second detection coil 40B1 and the second detection coil 40B2 are less than the threshold value Vth, thereby determining whether the terminal device 20 is present within the estimated chargeable range 64.

When it is determined that the terminal device 20 is outside the estimated chargeable range 64 (Step S102: No), the process proceeds to Step S104. In Step S104, the movement mechanism control unit 50C controls the movement mechanism 34 so as not to move the power transmission coil 30 (Step S104). That is, the movement mechanism control unit 50C does not transmit a signal related to a movement instruction to the movement mechanism 34. Then, the process returns to Step S100 described above.

On the other hand, in a case where it is determined that the terminal device 20 is present within the estimated chargeable range 64 (Step S102: Yes), the process proceeds to Step S106. In Step S106, the movement mechanism control unit 50C controls the movement mechanism 34 to move the power transmission coil 30 to the arrangement position identified in Step S100 (Step S106). By the processing in Step S106, the power transmission coil 30 is moved to the arrangement position of the terminal device 20.

Next, the communication determination unit 50D determines whether the power transmission coil 30 is capable of communicating with the terminal device 20 (Step S108). The communication determination unit 50D determines whether the power transmission coil 30 is capable of communicating with the terminal device 20 when the power transmission coil 30 reaches the arrangement position of the terminal device 20 as a result of the processing in Step S106. As described above, the communication determination unit 50D determines whether the power transmission coil 30 can communicate with the terminal device 20 by using, for example, PING as a communication signal.

When the communication determination unit 50D determines that communication is impossible (Step S108: No), the process returns to Step S100. When the communication determination unit 50D determines that communication is possible (Step S108: Yes), the process proceeds to Step S110.

In Step S110, the power transmission control unit 50E causes the power transmission coil 30 to transmit power (Step S110). By the processing of Step S110, wireless charging of the battery 24 of the terminal device 20 is started. Then, this routine is ended.

As described above, the charging device 10A of the present embodiment is the charging device 10 that performs wireless charging on the terminal device 20 including the power receiving unit 22 that is disposed on the placement surface 12A and receives wirelessly transmitted power. The charging device 10A of the present embodiment includes a power transmission coil 30, a power transmission control unit 50E, a detection coil 40, a signal output unit 46, and a determination unit 50B.

The power transmission coil 30 transmits power to the terminal device 20. The power transmission control unit 50E causes the power transmission coil 30 to transmit power. The detection coil 40 is a coil for detecting an arrangement position of the terminal device 20 on the placement surface 12A. The signal output unit 46 outputs, to the detection coil 40, a first signal for generating a detection magnetic field. The signal detection unit 48 detects an echo signal returned from the terminal device 20 to the detection coil 40 in response to the detection magnetic field. The determination unit 50B determines whether the terminal device 20 is present within the estimated chargeable range 64 by the power transmission coil 30 on the basis of the detection result of the echo signal.

In the related art, there have been cases where wireless charging has started unconditionally when the terminal device 20 is placed on the placement surface 12A. In addition, in the conventional technology, regardless of whether the arrangement position of the terminal device 20 is within the estimated chargeable range 64 or not, the movement of the power transmission coil is started toward the arrangement position of the terminal device 20 placed on the placement surface 12A, and wireless charging is started from the power transmission coil to the terminal device. Therefore, in the conventional technology, even if the terminal device 20 is placed in a position where wireless charging is difficult, movement of the power transmission coil and wireless charging may be initiated, resulting in increased power consumption.

On the other hand, in the charging device 10A of the present embodiment, the determination unit 50B determines whether the terminal device 20 is present within the estimated chargeable range 64 of the power transmission coil 30.

Therefore, in the charging device 10A of the present embodiment, the wireless charging, the movement of the power transmission coil 30, and the like can be controlled using the determination result as to whether the terminal device 20 exists within the estimated chargeable range 64. That is, in the charging device 10A, it is possible to suppress control such as useless movement of the power transmission coil 30 and wasteful start of wireless charging.

Therefore, the charging device 10A of the present embodiment can achieve power saving.

In addition, the charging device 10A of the present embodiment can include the arrangement position identifying unit 50A and the movement mechanism control unit 50C. The arrangement position identifying unit 50A identifies the arrangement position of the terminal device 20 based on the detection result of the signal detection unit 48. The movement mechanism 34 moves the power transmission coil 30. The movement mechanism control unit 50C controls the movement mechanism 34 based on the detection result.

In detail, when it is determined that the terminal device 20 is outside the estimated chargeable range 64, the arrangement position identifying unit 50A controls the movement mechanism 34 so as not to move the power transmission coil 30. Furthermore, when it is determined that the terminal device 20 is present within the estimated chargeable range 64, the arrangement position identifying unit 50A controls the movement mechanism 34 to move the power transmission coil 30 to the arrangement position of the terminal device 20.

In the conventional technology equipped with the movement mechanism 34 for the power transmission coil 30, regardless of whether the arrangement position of the terminal device 20 is within the estimated chargeable range 64 or not, the power transmission coil 30 starts moving toward the arrangement position of the terminal device 20 placed on the placement surface 12A, and wireless charging is started from the power transmission coil 30 to the terminal device 20.

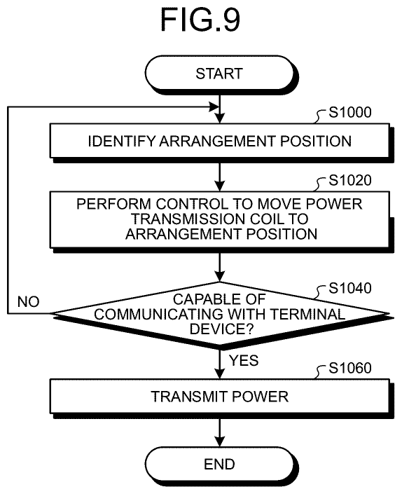

FIG. 9 is a flowchart illustrating an example of a flow of charging control of a charging device of the related art.

When the control unit of the conventional charging device identifies the arrangement position of the terminal device 20 (Step S1000), the control unit performs movement control of the power transmission coil 30 to the arrangement position (Step S1020). Then, the control unit of the conventional charging device determines whether the power transmission coil 30 is controlled to move to the arrangement position can communicate with the terminal device 20 (Step S1040). If the control unit determines that communication is not possible (Step S1040: No), the process returns to Step S1000. When determining that communication is possible (Step S1040: Yes), the control unit transmits power to the terminal device 20 (Step S1060), and ends this routine.

As illustrated in FIG. 9, in the charging control of a conventional charging device, the movement of the power transmission coil 30 toward the arrangement position of the terminal device 20 placed on the placement surface 12A is started without determining whether the terminal device 20 is present within the estimated chargeable range 64 of the power transmission coil 30. Therefore, in the related art, even when the terminal device 20 is placed at a position where wireless charging is not possible, movement control of the power transmission coil 30 is performed, and power consumption due to motor driving or the like of the drive motor 34A, the drive motor 34B, and the like increases.

On the other hand, in the charging device 10A of the present embodiment, it is determined whether the terminal device 20 is present within the estimated chargeable range 64 of the power transmission coil 30. When it is determined that the terminal device 20 is present within the estimated chargeable range 64, the charging device 10A controls the movement mechanism 34 to move the power transmission coil 30 to the arrangement position of the terminal device 20.

Therefore, the charging device 10A of the present embodiment can suppress unnecessary movement of the power transmission coil 30. That is, the charging device 10A of the present embodiment can effectively achieve power saving in addition to the above-mentioned effects.

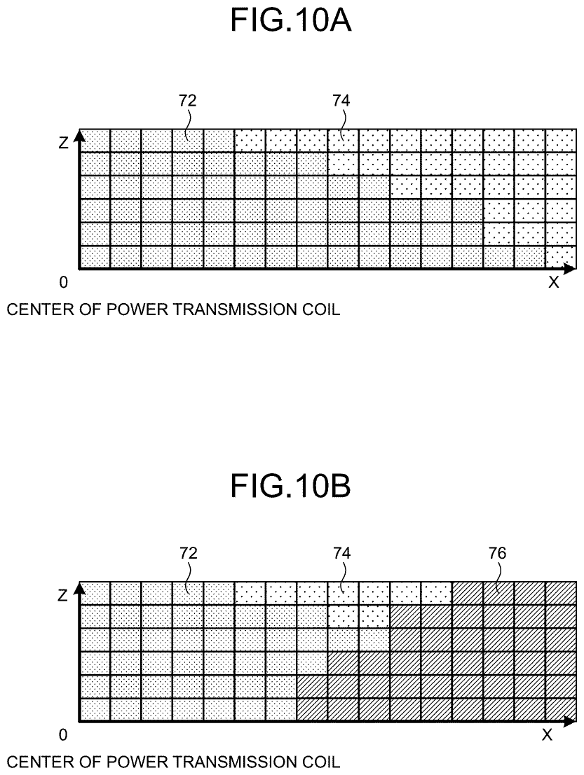

FIGS. 10A and 10B are explanatory diagrams illustrating an example of the effect of the charging device 10A of the present embodiment. FIG. 10A is an explanatory diagram of an example of control contents by a conventional charging device when the power receiving unit 22 of the terminal device 20 is located in each area of a space on the placement surface 12A. FIG. 10B is an explanatory diagram of an example of control contents by the charging device 10A of the present embodiment when the power receiving unit 22 of the terminal device 20 is located in each region of the space on the placement surface 12A.

In FIGS. 10A and 10B, the horizontal axis represents the distance in the X-axis direction on the placement surface 12A. FIGS. 10A and 10B illustrate a distance in the X-axis direction in which an origin “0” is a midpoint between the second detection coil 40B1 and the second detection coil 40B2 in the X-axis direction of the placement surface 12A. The vertical axis represents the distance in the Z-axis direction between the placement surface 12A and the power receiving unit 22 of the terminal device 20 when the placement surface 12A is the origin “0”.

In FIGS. 10A and 10B, a region 72 represents a region in which charging is started in the real space. A region 74 represents a region where the arrangement position is detected by the detection coil 40 but charging is not started. A region 76 represents a region where movement control and charging of the power transmission coil 30 are not started.

As illustrated in FIG. 10B, in the charging device 10A of the present exemplary embodiment, compared with the conventional charging device illustrated in FIG. 10A, a range of the region 76 in which the movement control of the power transmission coil 30 is not performed in the space on the placement surface 12A is wide.

Therefore, it can be said that the charging device 10A of the present embodiment can effectively achieve power saving as compared with the conventional charging device.

### Second Embodiment

In the present embodiment, a mode will be described in which whether the terminal device 20 is present within the estimated chargeable range 64 is determined when it is determined that the power transmission coil 30 has moved to the arrangement position cannot communicate with the terminal device 20.

In the present embodiment, the same reference numerals are given to portions representing the same functions or the same configurations as those of the above-described present embodiment, and a detailed description thereof will be omitted.

FIG. 3 is a block diagram illustrating an example of the configuration of a charging device 10B of the present embodiment. The charging device 10B is an example of the charging device 10.

The charging device 10B has the same configuration as the charging device 10A of the above embodiment except that a control unit 52 is provided instead of the control unit 50.

The control unit 52 includes an arrangement position identifying unit 50A, a determination unit 52B, a movement mechanism control unit 52C, a communication determination unit 50D, and a power transmission control unit 50E. The control unit 52 is similar to the control unit 50 of the above embodiment except that the determination unit 52B is provided instead of the determination unit 50B, and the movement mechanism control unit 52C is provided instead of the movement mechanism control unit 50C.

The movement mechanism control unit 52C controls the movement mechanism 34 based on the detection result by the signal detection unit 48, similar to the movement mechanism control unit 50C of the above embodiment.

In the present embodiment, when the arrangement position identifying unit 50A identifies the arrangement position of the terminal device 20 based on the detection result of the signal detection unit 48, the movement mechanism control unit 52C controls the movement mechanism 34 to move the power transmission coil 30 to the arrangement position.

That is, in the present embodiment, the movement mechanism control unit 52C controls the movement mechanism 34 to move the power transmission coil 30 to the identified arrangement position before it is determined whether the terminal device 20 is present in the estimated chargeable range 64. The movement mechanism control unit 52C may control the movement of the movement mechanism 34 in the same manner as the movement mechanism control unit 50C except that the timing of the movement control of the movement mechanism 34 is different from that of the movement mechanism control unit 50C of the above-described present embodiment.

The determination unit 52B determines whether the terminal device 20 is present within the estimated chargeable range 64 of the power transmission coil 30, based on the detection result of the echo signal by the signal detection unit 48, similar to the determination unit 50B in the present embodiment.

In detail, similar to the determination unit 50B, the determination unit 52B receives the detection result of the echo signal returned from the terminal device 20 to the second detection coil 40B in response to the detection magnetic field generated by the first signal output from the signal output unit 46 to the second detection coil 40B. Then, the determination unit 52B determines whether the terminal device 20 is present within the estimated chargeable range 64 based on the detection result.

In this embodiment, when it is determined that the power transmission coil 30 that has been controlled to move to its arrangement position is unable to communicate with the terminal device 20, the determination unit 52B determines whether the terminal device 20 is present within the estimated chargeable range 64 based on the detection result of the signal detection unit 48.

That is, in the present embodiment, when the power transmission coil 30 is controlled to move toward the arrangement position and it is determined that communication with the terminal device 20 is not possible, the determination unit 52B determines whether the terminal device 20 is present within the estimated chargeable range 64. Except that the determination timing is different from that of the determination unit 52B of the present embodiment, the determination unit 50B may determine whether the terminal device 20 is present within the estimated chargeable range 64 in the same manner as the determination unit 50B.

Next, an example of the flow of charging processing executed by the charging device 10B of the present embodiment will be described.

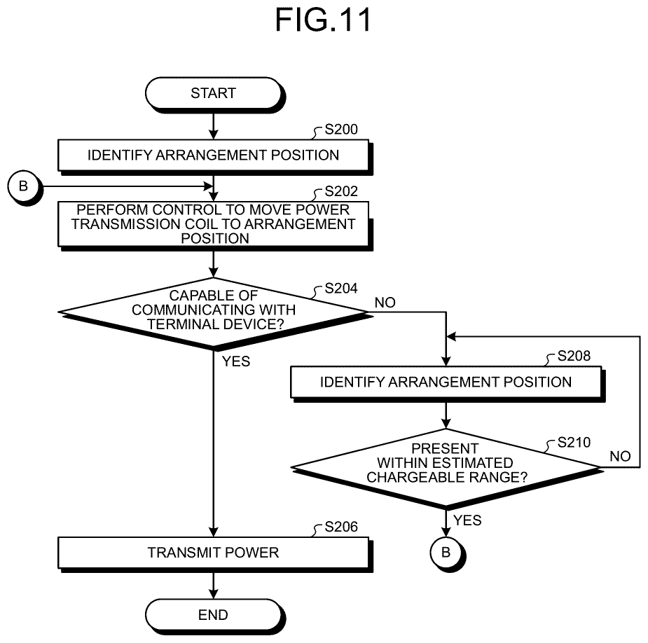

FIG. 11 is a flowchart illustrating an example of the flow of the charging process executed by the charging device 10B of the present embodiment.

The arrangement position identifying unit 50A identifies the arrangement position of the terminal device 20 based on the detection result of the signal detection unit 48 (Step S200). The arrangement position identifying unit 50A identifies the arrangement position of the terminal device 20 in a similar manner to Step S100 (see FIG. 8) of the present embodiment.

The movement mechanism control unit 52C controls the movement mechanism 34 to move the power transmission coil 30 to the arrangement position identified in Step S200 (Step S202). By the process of Step S202, the power transmission coil 30 is controlled to move toward the arrangement position of the terminal device 20.

The communication determination unit 50D determines whether the power transmission coil 30 is capable of communicating with the terminal device 20 (Step S204). The communication determination unit 50D determines whether the power transmission coil 30 is capable of communicating with the terminal device 20 by using a PING as a communication signal, similarly to the present embodiment.

When the communication determination unit 50D determines that communication is possible (Step S204: Yes), the process proceeds to Step S206. In Step S206, the power transmission control unit 50E causes the power transmission coil 30 to transmit power (Step S206). By the process of Step S206, wireless charging of the battery 24 of the terminal device 20 is started. Then, this routine is ended.

On the other hand, when the communication determination unit 50D determines that communication is not possible (Step S204: No), the process proceeds to Step S208. In Step S208, the arrangement position identifying unit 50A identifies the arrangement position of the terminal device 20 based on the detection result of the signal detection unit 48 (Step S208). The processing in Step S208 is similar to that in Step S200 described above.

Next, the determination unit 52B determines whether the terminal device 20 is present within the estimated chargeable range 64 of the power transmission coil 30, based on the detection result of the echo signal (Step S210). Similar to the determination unit 50B in the present embodiment, the determination unit 52B determines whether the echo signals returned to the second detection coil 40B1 and the second detection coil 40B2 are less than the threshold value Vth, thereby determining whether the terminal device 20 is present within the estimated chargeable range 64.

If it is determined that the terminal device 20 is present within the estimated chargeable range 64 (Step S210: Yes), the process proceeds to Step S202. When it is determined that the terminal device 20 is outside the estimated chargeable range 64 (Step S210: No), the process proceeds to Step S208.

As described above, in the charging device 10B of the present embodiment, when the arrangement position of the terminal device 20 is identified based on the detection result, the movement mechanism control unit 52C controls the movement mechanism 34 to move the power transmission coil 30 to the arrangement position. When it is determined that the power transmission coil 30 that has been controlled to move to the arrangement position is unable to communicate with the terminal device 20, the determination unit 52B determines whether the terminal device 20 is present within the estimated chargeable range 64 based on the detection result of the signal detection unit 48.

Here, in the related art including the movement mechanism 34 of the power transmission coil 30, when it is determined that the power transmission coil 30 and the terminal device 20 cannot communicate with each other, the movement control of the power transmission coil 30 is repeatedly executed until it is determined that the communication is possible.

Specifically, as illustrated in the flowchart of the charge control of the conventional charging device illustrated in FIG. 9, in the conventional technique, the movement control of the power transmission coil 30 is repeatedly executed until it is determined that communication is possible (Step S1040: Yes) (Step S1040: No, see Step S1000 and Step S1020).

On the other hand, in the charging device 10B of the present embodiment, the movement mechanism control unit 52C controls the movement of the power transmission coil 30 toward the arrangement position, and after the communication determination unit 50D determines that communication is impossible, it is determined whether the terminal device 20 is present in the estimated chargeable range 64 (see FIG. 11). In the charging device 10B of the present embodiment, when it is determined that the terminal device 20 is present within the estimated chargeable range 64, the charging device 10B controls the movement mechanism 34 to move the power transmission coil 30 to the arrangement position.

Therefore, the charging device 10B of the present embodiment can prevent unnecessary repetition of movement of the power transmission coil 30, compared to conventional charging devices. That is, the charging device 10B of the present embodiment can effectively achieve power saving, similar to the charging device 10A of the above-described present embodiment.

In addition, as compared with the charging device 10A of the above-described present embodiment, the charging device 10B of the present embodiment can expand the range of the chargeable region on the placement surface 12A while minimizing the movement of the power transmission coil 30.

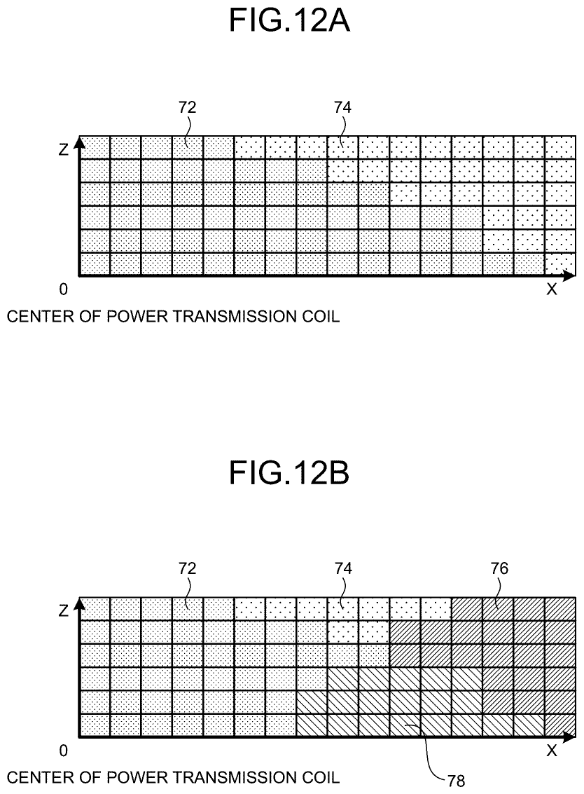

FIGS. 12A and 12B are explanatory diagrams illustrating an example of the effect of the charging device 10B of the present embodiment. FIG. 12A is an explanatory diagram of an example of the control content by a charging device of the related art when the power receiving unit 22 of the terminal device 20 is located in each region of the space on the placement surface 12A. FIG. 12B is an explanatory diagram of an example of the control contents by the charging device 10B of this embodiment when the power receiving unit 22 of the terminal device 20 is located in each region of the space on the placement surface 12A.

In FIGS. 12A and 12B, the horizontal axis represents the distance in the X-axis direction on the placement surface 12A. FIGS. 12A and 12B illustrate the distance in the X-axis direction, with the midpoint between the second detection coil 40B1 and the second detection coil 40B2 in the X-axis direction of the placement surface 12A set as the origin “0”. The vertical axis represents the distance in the Z-axis direction between the placement surface 12A and the power receiving unit 22 of the terminal device 20 when the placement surface 12A is the origin “0”.

In FIGS. 12A and 12B, the region 72, the region 74, and the region 76 are the same as those in the above-described present embodiment. That is, the region 72 represents the region in real space where charging begins. The region 74 represents a region where the arrangement position is detected by the detection coil 40 but charging is not started. A region 76 represents a region where movement control and charging of the power transmission coil 30 are not started. In addition, in FIG. 12B, a region 78 represents a region where charging is started without performing movement control of the power transmission coil 30 when the power transmission coil 30 and the power receiving unit 22 can communicate with each other.

As illustrated in FIG. 12B, in a charging device 10B of this embodiment, the range of the region 76 in the space above the placement surface 12A where movement control of the power transmission coil 30 is not performed is wider than in the conventional charging device illustrated in FIG. 12A. For this reason, it can be said that the charging device 10B of the present embodiment can effectively achieve power saving compared to the conventional charging devices.

In addition, as illustrated in FIG. 12B, in the charging device 10B of the present embodiment, the range of the region to start charging represented by the region 72 and the region 78 is wider than that of the charging device 10A of the above-described embodiment illustrated in FIG. 10B. For this reason, it can be said that the charging device 10B of the present embodiment can expand the range of the chargeable region on the placement surface 12A while minimizing the movement of the power transmission coil 30, compared to the charging device 10A of the above-described present embodiment.

### Third Embodiment

In the present embodiment, a mode for adjusting a level of a communication signal used for determining whether communication with the power transmission coil 30 is possible will be described.

In the present embodiment, the same reference numerals are given to portions representing the same functions or the same configurations as those of the above-described present embodiment, and a detailed description thereof will be omitted.

FIG. 3 is a block diagram illustrating an example of the configuration of a charging device 10C of the present embodiment. The charging device 10C is an example of the charging device 10.

The charging device 10C has the same configuration as the charging device 10A of the above-described present embodiment, except that the charging device 10C includes a control unit 53 instead of the control unit 50.

The control unit 53 includes an arrangement position identifying unit 50A, a determination unit 53B, a movement mechanism control unit 52C, a communication determination unit 53D, and a power transmission control unit 50E. The arrangement position identifying unit 50A, the movement mechanism control unit 52C, and the power transmission control unit 50E are the same as those in the above-described present embodiment.

When the movement mechanism control unit 52C controls the movement of the power transmission coil 30 to the arrangement position identified by the arrangement position identifying unit 50A, the determination unit 53B determines whether the terminal device 20 is present within the estimated chargeable range 64 based on the detection result of the signal detection unit 48.

The determination unit 53B may determine whether the terminal device 20 is present within the estimated chargeable range 64 in the same manner as the determination unit 50B, except that the determination timing differs from that of the determination unit 50B of the above-described present embodiment.

The communication determination unit 53D determines whether the power transmission coil 30 is capable of communicating with the terminal device 20, similar to the communication determination unit 50D. The communication determination unit 53D determines whether communication with the terminal device 20 is possible using a communication signal such as PING, similar to the communication determination unit 50D.

In the present embodiment, the communication determination unit 53D determines whether communication with the terminal device 20 is possible using a communication signal of a voltage level corresponding to a determination result by the determination unit 53B.

In detail, when it is determined that the terminal device 20 is present within the estimated chargeable range 64, the communication determination unit 53D uses a communication signal of a first voltage that is equal to or lower than a first threshold value to determine whether the power transmission coil 30, which has been controlled to move to its arrangement position, is capable of communicating with the terminal device 20.

In addition, in a case where it is determined that the terminal device 20 is outside the estimated chargeable range 64, the communication determination unit 53D uses a communication signal of a second voltage equal to or higher than a second threshold value larger than the first threshold value to determine whether the power transmission coil 30 whose movement is controlled to the arrangement position can communicate with the terminal device 20.

The first threshold value may be determined in advance. For example, as the first threshold value, a value at which a communication signal having the first voltage equal to or lower than the first threshold value becomes a voltage level of a communication signal used for normal communication confirmation may be determined in advance.

As the second threshold value, a value larger than the first threshold value may be determined in advance. For example, the second threshold value may be set in advance to a value at which, when the communication signal having the second voltage equal to or higher than the second threshold value exceeds the voltage level of the communication signal used for normal communication check and reaches the power receiving unit 22 of the terminal device 20, the terminal device 20 is not electrically destroyed by the high voltage.

Then, the control unit 53 of the charging device 10C may start wireless charging of the terminal device 20 when determining that communication is possible by the communication signal of the first voltage or the communication signal of the second voltage.

Next, an example of the flow of charging processing executed by the charging device 10C of the present embodiment will be described.

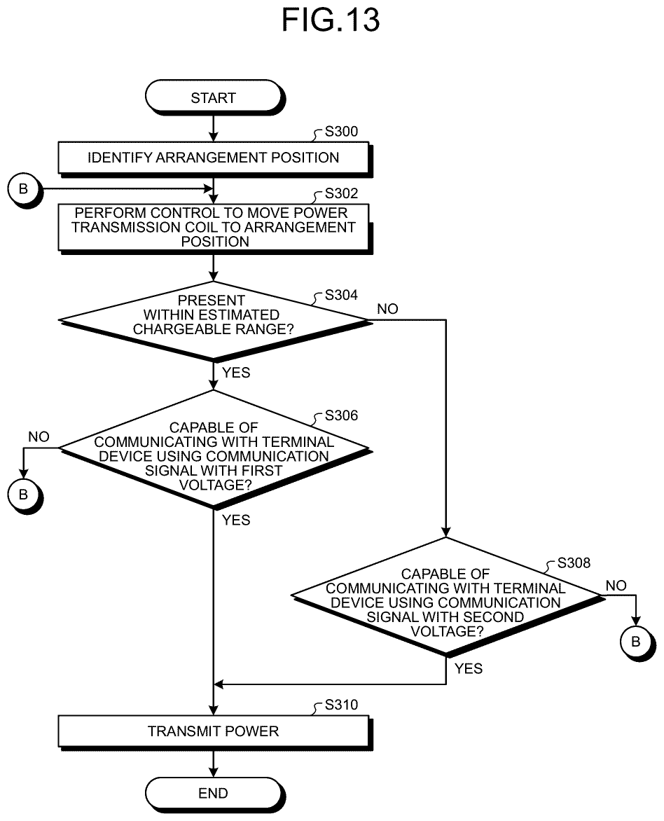

FIG. 13 is a flowchart illustrating an example of the flow of the charging process executed by the charging device 10C of the present embodiment.

The arrangement position identifying unit 50A identifies the arrangement position of the terminal device 20 based on the detection result of the signal detection unit 48 (Step S300). The arrangement position identifying unit 50A identifies the arrangement position of the terminal device 20 in a similar manner to Step S100 (see FIG. 8) of the present embodiment.

The movement mechanism control unit 52C controls the movement mechanism 34 to move the power transmission coil 30 to the arrangement position identified in Step S300 (Step S302). By the process of Step S302, the power transmission coil 30 is controlled to move toward the arrangement position of the terminal device 20.

Next, the determination unit 53B determines whether the terminal device 20 is present within the estimated chargeable range 64 of the power transmission coil 30, based on the detection result of the echo signal (Step S304). Similar to the determination unit 50B in the above-described present embodiment, the determination unit 53B determines whether the echo signals returned to the second detection coil 40B1 and the second detection coil 40B2 are less than the threshold value Vth, thereby determining whether the terminal device 20 is present within the estimated chargeable range 64.

when it is determined that the terminal device 20 is present within the estimated chargeable range 64 (Step S304: Yes), the process proceeds to Step S306.

In Step S306, the communication determination unit 53D determines whether the power transmission coil 30 is capable of communicating with the terminal device 20 within the estimated chargeable range 64, using a communication signal with the first voltage that is equal to or less than the first threshold value (Step S306). When it is determined in Step S306 that communication is possible (Step S306: Yes), the process proceeds to Step S310, which will be described below. When it is determined in Step S306 that communication is not possible (Step S306: No), the process returns to Step S300.

On the other hand, when it is determined that the terminal device 20 is outside the estimated chargeable range 64 (Step S304: No), the process proceeds to Step S308.

In Step S308, the communication determination unit 53D determines whether the power transmission coil 30 is capable of communicating with the terminal device 20 outside the estimated chargeable range 64, using a communication signal with the second voltage equal to or higher than the second threshold value (Step S308). When it is determined in Step S308 that communication is not possible (Step S308: No), the process returns to Step S300. When it is determined in Step S308 that communication is possible (Step S308: Yes), the process proceeds to Step S310.

In Step S310, the power transmission control unit 50E causes the power transmission coil 30 to transmit power (Step S310). By the process of Step S310, wireless charging of the battery 24 of the terminal device 20 is started. Then, this routine is ended.

As described above, in the charging device 10C of the present embodiment, when the power transmission coil 30 is controlled to move to the arrangement position, the determination unit 53B determines whether or not the terminal device 20 is present within the estimated chargeable range 64 based on the detection result. When it is determined that the terminal device 20 is present within the estimated chargeable range 64, the communication determination unit 50D uses a communication signal of a first voltage that is less than or equal to a first threshold value to determine whether the power transmission coil 30, which has been controlled to move to its arrangement position, is capable of communicating with the terminal device 20. In addition, when it is determined that the terminal device 20 is outside the estimated chargeable range 64, the communication determination unit 50D uses a communication signal of a second voltage equal to or greater than a second threshold value that is greater than the first threshold value to determine whether the power transmission coil 30, which has been controlled to move to its arrangement position, is able to communicate with the terminal device 20.

Here, in the related art including the movement mechanism 34 of the power transmission coil 30, when it is determined that the power transmission coil 30 and the terminal device 20 cannot communicate with each other, the movement control of the power transmission coil 30 is repeatedly executed until it is determined that the communication is possible. In detail, as illustrated in the flowchart of charging control of the related art in FIG. 9, in the technology of the related art, movement control of the power transmission coil 30 was repeatedly executed (see Step S1040: No, Step S1000, Step S1020) until it is determined that communication is possible (Step S1040: Yes).

On the other hand, in the charging device 10C of the present embodiment, depending on whether the terminal device 20 is present within the estimated chargeable range 64, it is determined whether the power transmission coil 30 is able to communicate with the terminal device 20 using a communication signal of the second voltage. That is, when the charging device 10C determines that the terminal device 20 is outside the estimated chargeable range 64, it determines whether the power transmission coil 30 is able to communicate with the terminal device 20 using a communication signal of the second voltage equal to or greater than a second threshold value that is greater than the first threshold value. Then, in a case where it is determined that communication is possible, the charging device 10C starts wireless charging of the terminal device 20, and in a case where it is determined that communication is not possible, the arrangement position of the terminal device 20 and the movement control of the power transmission coil 30 are executed.

As described above, the charging device 10C of the present embodiment determines whether the terminal device 20 can communicate with the terminal device 20 by using communication signals of different voltage levels depending on whether the terminal device exists within the estimated chargeable range 64 or outside the estimated chargeable range 64.

Therefore, the charging device 10C of the present embodiment can prevent unnecessary repetition of movement of the power transmission coil 30, compared to conventional charging devices. That is, the charging device 10C of this embodiment can effectively achieve power saving, similar to the charging device 10A of the above-described present embodiment.

In addition, when the charging device 10C of this embodiment determines that the terminal device 20 is outside the estimated chargeable range 64, it determines whether the power transmission coil 30 is able to communicate with the terminal device 20 using a communication signal of the second voltage that is equal to or greater than the second threshold value that is greater than the first threshold value. Therefore, it is possible to expand a region where charging can be started in the space on the placement surface 12A as compared with a mode in which wireless charging is not started when the terminal device 20 is outside the estimated chargeable range 64.

### First Modification Example

In the above-described present embodiment, the detection coil 40 configured by the first detection coil 40A and the second detection coil 40B is described as an example. In this modification example, a mode in which a plurality of detection coils 40 are extended in each of the X-axis direction and the Y-axis direction and arranged so as to cross each other will be described as an example.

In this modification example, parts having the same functions or configurations as those in the above-described present embodiment are given the same reference numerals as those in the above-described present embodiment, and detailed descriptions thereof will be omitted.

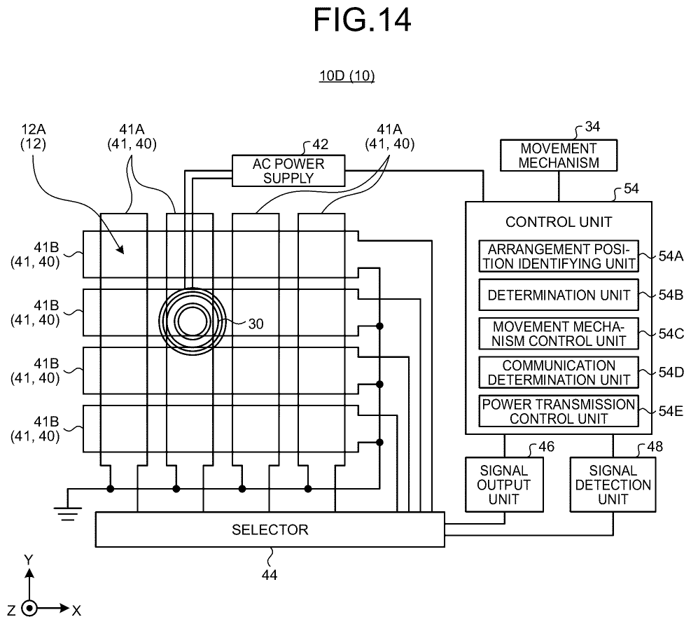

FIG. 14 is a block diagram illustrating an example of the configuration of a charging device 10D of this modification example. The charging device 10D is an example of the charging device 10.

The charging device 10D has the same configuration as the charging device 10A to the charging device 10C of the above-described present embodiment except that a plurality of coils 41 are provided as the detection coils 40 instead of the first detection coil 40A and the second detection coil 40B, and a control unit 54 is provided instead of the control unit 50.

In this modification example, the detection coil 40 includes the plurality of coils 41 extending in the first direction (X-axis direction) on a two-dimensional plane along the placement surface 12A and arranged along the second direction (Y-axis direction) intersecting the first direction, and extending in the second direction (Y-axis direction) and arranged along the first direction (X-axis direction).

Specifically, the coil 41 includes a coil 41A and a coil 41B.

The coils 41A are coils extending in the Y-axis direction and arranged along the X-axis direction. The coils 41B are coils extending in the X-axis direction and arranged along the Y-axis direction.

In this modification example, a detection range 60 on the placement surface 12A is a region where the detection coil 40, which is the coil 41 including the plurality of coils 41A and the plurality of coils 41B, is disposed. As in the above-described present embodiment, the detection range 60 includes the entire region of the movable range 62 and the estimated chargeable range 64, and is a range wider than these ranges.

The detection coil 40 consisting of the plurality of coils 41 is electrically connected to each of the signal output unit 46 and the signal detection unit 48 via the selector 44. The signal output unit 46 and the signal detection unit 48 are similar to those in the above-described present embodiment.

The control unit 54 includes an arrangement position identifying unit 54A, a determination unit 54B, a movement mechanism control unit 54C, a communication determination unit 54D, and a power transmission control unit 54E.

The arrangement position identifying unit 54A identifies the arrangement position of the terminal device 20 based on the detection result of the signal detection unit 48, similarly to the arrangement position identifying unit 50A of the above-described present embodiment. The arrangement position identifying unit 54A identifies the arrangement position of the terminal device 20 based on the level of the echo signal that is the detection result of the signal detection unit 48, similar to the arrangement position identifying unit 50A.

In this modification example, the arrangement position identifying unit 54A responds to the detection magnetic field generated by the first signal output from the signal output unit 46 to each of the coils 41 included in the detection coil 40, and identifies the arrangement position based on the detection result of the echo signal returned from the terminal device 20 to the coils 41.

In detail, the arrangement position identifying unit 54A determines whether an echo signal returned to any coil 41A among the plurality of coils 41A arranged along the X-axis direction is equal to or higher than a predetermined level. Through this determination, the arrangement position identifying unit 54A identifies the position of the terminal device 20 in the X-axis direction within the detection range 60 on the placement surface 12A. Specifically, the arrangement position identifying unit 54A identifies the position of the coil 41A that outputs an echo signal that is equal to or higher than a predetermined level and has the maximum level among the echo signals of each of the plurality of coils 41A detected by the signal detection unit 48 as the position of the terminal device 20 in the X-axis direction.

Moreover, the arrangement position identifying unit 54A determines whether an echo signal returned to any coil 41B among the plurality of coils 41B arranged along the Y-axis direction is equal to or higher than a predetermined level. Through this determination, the arrangement position identifying unit 54A identifies the position of the terminal device 20 in the Y-axis direction within the detection range 60 on the placement surface 12A. Specifically, the arrangement position identifying unit 54A identifies the position of the coil 41B that outputs an echo signal that is equal to or higher than a predetermined level and has the maximum level among the echo signals of each of the multiple coils 41B detected by the signal detection unit 48 as the position of the terminal device 20 in the Y-axis direction.

Through these processes, the arrangement position identifying unit 54A identifies the arrangement position of the terminal device 20 represented by the position in the X-axis direction and the position in the Y-axis direction on the two-dimensional plane of the placement surface 12A.

The arrangement position identifying unit 54A identifies the arrangement position of the terminal device 20 at the same timing as the arrangement position identifying unit 50A of the above-described present embodiment except that the method of identifying the arrangement position of the terminal device 20 is different.

Similar to the determination units 50B, 52B, and 54B in the above-described present embodiments, the determination unit 54B determines whether or not the terminal device 20 is present within the estimated chargeable range 64 of the power transmission coil 30 based on the detection result of the echo signal.

In this modification example, the determination unit 54B performs determination processing using the arrangement position of the terminal device 20 identified by the arrangement position identifying unit 54A on the basis of the detection result of the echo signal. As described above, in the present embodiment, the arrangement position identifying unit 54A identifies the arrangement position of the terminal device 20 represented by the position in the X-axis direction and the position in the Y-axis direction on the two-dimensional plane of the placement surface 12A. Therefore, the determination unit 54B determines whether the arrangement position identified by the arrangement position identifying unit 54A is located within the range of the estimated chargeable range 64 stored in advance, thereby determining whether the terminal device 20 is present within the estimated chargeable range 64.

The determination unit 54B determines whether the terminal device 20 is present in the estimated chargeable range 64 at the same timing as each of the determination unit 50B, the determination unit 52B, or the determination unit 53B of the above-described embodiment except that the method of determining whether the terminal device 20 is present in the estimated chargeable range 64 is different from that of the above-described present embodiment.

The processing of the movement mechanism control unit 54C, the communication determination unit 54D, and the power transmission control unit 54E is similar to that in the above-described present embodiment. That is, the movement mechanism control unit 54C is similar to the movement mechanism control unit 50C or the movement mechanism control unit 52C of the above-described present embodiment. The communication determination unit 54D is similar to the communication determination unit 50D or the communication determination unit 53D of the above-described present embodiment. In addition, the power transmission control unit 54E is similar to the power transmission control unit 50E of the above-described present embodiment.

The control unit 54 of the charging device 10D of the present modification example executes the same processing as each of the control unit 50, the control unit 52, and the control unit 53 of the above-described embodiment except that the method of identifying the arrangement position by the arrangement position identifying unit 54A and the method of determining by the determination unit 54B are different from those of the above-described embodiment.

As described above, even in a case where the position represented by the position in the X-axis direction and the position in the Y-axis direction on the two-dimensional plane of the placement surface 12A is used as the arrangement position of the terminal device 20, power saving can be achieved similarly to the above-described present embodiment.

According to the present disclosure, power saving can be achieved.

Although the above-described present embodiment and the modification have been described above, the embodiment and the modification example have been presented as examples, and are not intended to limit the scope of the invention. The above-described novel embodiments and modification examples can be implemented in various other forms, and various omissions, substitutions, and changes can be made without departing from the gist of the invention. The above-described present embodiments and modification examples are included in the scope or gist of the invention, and are included in the invention described in the claims and the equivalent scope thereof.

What is claimed is:

1. A charging device that wirelessly charges a terminal device having a power receiver that is disposed on a placement surface and receives wirelessly transmitted power, the charging device comprising:
a power transmission coil that transmits power to the terminal device;
a memory;
a processor coupled to the memory and configured to cause the power transmission coil to transmit power;
a detection coil for detecting an arrangement position of the terminal device on the placement surface;
a signal transmitter that outputs, to the detection coil, a first signal for generating a detection magnetic field; and
a signal detector that detects an echo signal returned from the terminal device to the detection coil in response to the detection magnetic field, wherein
the processor is further configured to determine whether the terminal device is present within an estimated chargeable range by the power transmission coil, based on a detection result of the echo signal.

2. The charging device according to claim 1, comprising
a movement mechanism that moves the power transmission coil, wherein
the processor is further configured to
identify the arrangement position based on a detection result of the signal detector; and
control the movement mechanism based on the detection result.

3. The charging device according to claim 2, wherein
the processor is configured to:
control the movement mechanism so as not to move the power transmission coil when it is determined that the terminal device is outside the estimated chargeable range; and
control the movement mechanism to move the power transmission coil to the arrangement position when it is determined that the terminal device is present within the estimated chargeable range.

4. The charging device according to claim 2, wherein
the processor is configured to
control the movement mechanism to move the power transmission coil to the arrangement position when the arrangement position is identified based on the detection result and it is determined that the terminal device is present within the estimated chargeable range based on the detection result.

5. The charging device according to claim 2, wherein
the processor is further configured to determine whether the power transmission coil that moves to the arrangement position is capable of communicating with the terminal device, and
the processor is configured to controls the power transmission coil to transmit power to the terminal device when it is determined that it is capable of communicating.

6. The charging device according to claim 5, wherein
the processor is configured to:
control the movement mechanism to move the power transmission coil to the arrangement position when the arrangement position is identified based on the detection result; and
determine whether the terminal device is present within the estimated chargeable range, based on the detection result, when it is determined that the power transmission coil that is controlled to move to the arrangement position is not capable of communicating with the terminal device.

7. The charging device according to claim 5, wherein
the processor is configure to:
determine whether the terminal device is present within the estimated chargeable range, based on the detection result, when the power transmission coil is controlled to move to the arrangement position;
determine whether the power transmission coil that is controlled to move to the arrangement position is capable of communicating with the terminal device, using a communication signal of a first voltage that is equal to or less than a first threshold value, when it is determined that the terminal device is present within the estimated chargeable range; and
determine whether the power transmission coil that is controlled to move to the arrangement position is capable of communicating with the terminal device, using a communication signal of a second voltage that is equal to or greater than a second threshold value that is greater than the first threshold value, when it is determined that the terminal device is outside the estimated chargeable range.

8. The charging device according to claim 2, wherein
the detection coil includes:
a first detection coil for detecting the arrangement position of the terminal device in the estimated chargeable range on the placement surface; and
a second detection coil for detecting the arrangement position of the terminal device outside the estimated chargeable range on the placement surface,
the processor is configured to:
identify the arrangement position based on the detection result of the echo signal returned from the terminal device to at least the first detection coil in response to the detection magnetic field caused by the first signal output from the signal transmitter to at least the first detection coil; and
determine whether the terminal device is present within the estimated chargeable range, based on the detection result of the echo signal returned from the terminal device to the second detection coil in response to the detection magnetic field caused by the first signal output from the signal transmitter to the second detection coil.

9. The charging device according to claim 8, wherein
the first detection coil
extends in a first direction in a two-dimensional plane along the placement surface, and includes a plurality of first detection coils arranged along a second direction intersecting the first direction in the two-dimensional plane, and
the second detection coil
extends in the second direction and is includes second detection coils disposed at both ends of the first detection coil in the first direction.

10. The charging device according to claim 2, wherein
the detection coil
includes a plurality of coils extending in a first direction in a two-dimensional plane along the placement surface and arranged along a second direction intersecting the first direction, and a plurality of coils extending in the second direction and arranged along the first direction,
the processor is configured to:
identify the arrangement position based on the detection result of the echo signal returned from the terminal device to the detection coil in response to the detection magnetic field caused by the first signal output from the signal transmitter to the detection coil; and
determine whether the terminal device is present within the estimated chargeable range, based on the detection result of the echo signal returned from the terminal device to the detection coil in response to the detection magnetic field caused by the first signal output from the signal transmitter to the detection coil.
